(19) United States
(12) Patent Application Publication
(10) Pub. No.: US 2022/0390560 A1
(43) Pub. Date: Dec. 8, 2022

(54) Adaptive Active Safety System using Multi-spectral LIDAR, and Method implemented in the Adaptive Active Safety System

(71) Applicant: Outsight, Paris (FR)

(72) Inventor: Raul Bravo Orellana, Paris (FR)

(73) Assignee: Outsight, Paris (FR)

(21) Appl. No.: 17/774,253

(22) PCT Filed: Nov. 3, 2020
(86) PCT No.: PCT/EP2020/080835

§ 371 Date: May 4, 2022

Related U.S. Application Data
(63) Continuation-in-part of application No. 16/675,016, filed on Nov. 5, 2019, now abandoned.

(51) Int. Cl. G01S 7/48; G01S 17/894; G01S 17/931; B60W 40/06; B60W 30/09; B60W 30/14; B60W 50/14

(52) U.S. Cl. CPC G01S 7/4802; G01S 17/894; G01S 17/931; B60W 40/06; B60W 30/09; B60W 30/143; B60W 50/14; B60W 2420/52; B60W 2552/15; B60W 2552/40; B60W 2552/50; B60W 2552/53; B60W 2554/60

(57) ABSTRACT

We disclose adaptive active safety systems which utilize a sensing system to detect road conditions and actuate an active safety routine based thereon. One disclosed method includes transmitting, with a multispectral LIDAR system on a vehicle, a multispectral light beam directed at an anticipated region of travel of the vehicle within a road, and analyzing a response, of a photodetector, to a return of the multispectral light beam. The method also includes determining, based on the analyzing of the response, a hazardous surface condition in the anticipated region of travel of the vehicle, and actuating, based on the determination of the hazardous surface condition, an active safety routine. The method can be executed by an ADAS in which the determinations of the hazardous surface conditions on the road in the anticipated region of travel are executed in real time to thereby produce a road aware ADAS.

### CROSS REFERENCE TO RELATED APPLICATIONS

This application is a 35 U.S.C. § 371 National Stage of International Application No. PCT/EP2020/080835 filed Nov. 3, 2020, which claims priority to U.S. patent application Ser. No. 16/675,016 filed on Nov. 5, 2019 the disclosures of which are both incorporated by reference herein in their entirety for all purposes.

### BACKGROUND

Active safety systems increase road safety by perceiving and understanding the surroundings of a vehicle and mitigating the effect of any detected hazard present in those surroundings by either providing information to the operator or directly controlling the vehicle. One class of active safety systems are Advanced Driver Assistance Systems (ADAS) which are electronic systems that aid a vehicle driver to increase car safety and road safety generally. ADASs are developed to automate, adapt, and enhance vehicle systems for safety and better driving. These systems have been proven to reduce road fatalities by minimizing human error and increasing the awareness and response times of human operators.

This disclosure relates to all active safety systems, many examples of which are explicitly referenced in the detailed description below. The specific case of Adaptive Cruise Control (ACC) is discussed as follows strictly for purposes of explaining the related art and not as a limiting example of the scope of applicability of the approaches disclosed herein. ACC is a form of ADAS which automatically adjusts vehicle speed to maintain a safe distance from other vehicles. ACC is an example of an active safety system in that it must be able to actively sense the distance to the vehicle ahead and then control the vehicle to set the sensed distance to the safe distance.

FIG. 1 is a block diagram and flow chart 100 for the execution of an ACC system on a moving vehicle. The grey boxes represent the operation of various subsystems of the vehicle while the white boxes represent functional steps in the flow chart executed by those subsystems. This format is also applied in the remaining block diagrams and flow charts in this disclosure. As illustrated, a sensing system 101 scans the road ahead of the vehicle. This is illustrated by scan area 151 emanating from vehicle 150. The sensing system 101 will pass the information obtained from scanning to an active safety system 110. The active safety system can then detect a vehicle on the road, determine the detected vehicle's speed, determine the local speed (i.e., the speed of the vehicle on which the active safety system is located), calculate a braking time based on the local speed, and calculate a safe following distance based on the acquired information. This sensing of the detected vehicle is illustrated by scan area 151 encountering vehicle 152.

Upon calculating the following distance, the active safety system 110 can then either provide relevant information based thereon to a user via a user interface system 120, or issue commands to the vehicle control system 130. The user interface system 120 can include visible or auditory cues to the user if they have gone too far ahead of or too far behind the calculated following distance and prompt them to increase or decrease the cruising speed. Alternatively, the control system 130 can control the throttle, brake, or gear in a negative feedback loop with the sensing system 101 and active safety system 110 to guide the vehicle to the safe following distance automatically. The action of the active safety system 110 is illustrated by distance 153. Variant active safety systems provide similar benefits in terms of increased safety or increases in the amount of information provided to a human operator to improve their ability to safely pilot their vehicle.

### SUMMARY

Adaptive active safety systems are disclosed herein that utilize a sensing system to detect road conditions and actuate an active safety routine based on the detected road condition. The result is a road-aware active safety system that can provide feedback, directly to the vehicle or to the operator, that is optimized for current road conditions. The sensing system used to detect the road conditions can be the same sensing system which would be used by an equivalent active safety system without road condition awareness. However, the sensing system can also be a dedicated system used for road condition detection. The example of an ADAS is provided throughout this disclosure as an example of the types of systems that can be improved by the disclosed approaches. However, the approaches disclosed herein are equally applicable to any active safety system including those utilized by autonomous vehicles. Furthermore, the example of a multi-spectral light imaging detection and ranging (LIDAR) system is provided throughout this disclosure as an example of the types of sensing systems that can be utilized to detect road conditions. However, the current approaches can instead utilize any sensing system including any electromagnetic (e.g., radio frequency, visible light, optical), acoustic, gravimetric, barometric, or other sensing system.

Current ADAS solutions rely on fixed (i.e., hard-wired) road condition assumptions. For example, when calculating optimum following distance in the active safety system 110, the system will have a fixed value for the surface friction coefficient of the road surface. As used herein, the surface friction coefficient will also be referred to as the “grip” of the road. This aspect of current ADAS solutions leads to suboptimal outcomes as the surface friction coefficient, or other road conditions, can have a large impact on the behavior of a vehicle. For example, a wet road will, all else held equal, increase the actual braking distance. Some current systems allow a user to manually select the appropriate scenario for a given condition (e.g., being provided with the ability to select the “raining” condition for the active safety system). However, a user may forget to make this selection, and the limited number of scenarios might not fit the wide array of road conditions a vehicle may face. Suboptimal outcomes can take many forms based on the aspect of the active safety system which is affected by the road conditions. For example, a system may either not take into account the longer brake times required by a given condition and lead to an unsafe scenario, or the system will overcorrect for a worst case conditions and lead to systems that cause traffic build up, a suboptimal usage of road space, or worse—a situation in which an operator feels the system is inefficient and slow, and deactivates the system thereby completely mitigating any improvements to vehicle and general road safety that would otherwise have been provided by the system.

In specific embodiments of the invention, an electromagnetic sensing system located on a vehicle is utilized to detect a road condition in an anticipated region of travel for the vehicle and provide this information to an active safety system located on the vehicle. The electromagnetic sensor can be or include an optical, magnetic, radio frequency, or any other sensor used to detect the interaction of electrons or photons with the road in the anticipated region of travel. The electromagnetic sensor can be an imaging system using visible, ultraviolet, or infrared light sensing, whether active or passive, and any form of depth sensor or two-dimensional texture map sensor. The sensing systems can be augmented with computer vision processing capabilities to extract depth information from a two-dimensional image, segment two- or three-dimensional images, extract information regarding portions of the environment contained in the image, and semantically derive information regarding objects in the environment contained in the image. The sensing system can be passive and detect the interaction of the electrons or photons from an ambient or alternative source, or it can be active, and both produce and sense the electrons or photons that will be sensed by the sensor. As mentioned above, the sensing system can be used both directly by the active safety system and to determine road surface condition information for usage by the active safety system, or it can be a dedicated system specifically for determining road surface conditions.

In specific embodiments of the invention, the active safety system can actuate an active safety routine based on the detected condition of the road. Detection of the road condition can affect when an active safety routine is actuated or how the active safety routine is actuated, or both. Returning to the example of an ACC system, the sensing system can detect that the road is wet or dry, that it includes snow, ice, oil, gravel, etc. and determine, in real time, a grip of the road and an optimum following distance based thereon. The resulting system is an example of a road aware ADAS that features real time calculation of the safe braking distance calculation for a given road condition in the anticipated region of travel of the vehicle, and accordingly provides continuous optimization of the following distance.

A first object of the invention is a method is performed by a system embedded in a vehicle, comprising the steps of:

transmitting, with a multispectral lidar system, a multispectral light beam directed at an anticipated region of travel of the vehicle within a road;

analyzing a multispectral response, of a photodetector, to a return of the multispectral light beam;

determining, based on the analyzing of the multispectral response, a hazardous surface condition in the anticipated region of travel of the vehicle; and

actuating, based on the determination of the hazardous surface condition, an active safety routine; and

wherein the analyzing of the multispectral response includes a time of flight analysis and a multispectral intensity analysis, the time of flight analysis determining a distance between the multispectral lidar system and at least one point inside the anticipated region of travel, and the multispectral intensity analysis determining signature information of material of said at least one point, said signature information comprising at least two intensities at different wavelength.

In some embodiments, one might also use one or more of the following features:

According to some aspects:

the anticipated region of travel is a region of road excluding boundaries of the road by detecting boundaries features, boundaries features including lane markers, side rails, curbs, road signs, the boundaries features being detected by analyzing the multispectral response; and

the hazardous surface condition is determined based on the analyzing of the multispectral response corresponding to points on the road located only inside the anticipated region of travel.

According to some aspects, the actuating is further based on the determination of the inclination of the anticipated region of travel relative to an absolute horizontal direction, to identify if the anticipated region of travel is a rising portion of road or if the anticipated region of travel is a descendant portion of road.

According to some aspects, the multispectral light beam transmitted by the multispectral system scans both a potential encountering object to be detected in front of the vehicle and the road for determining the hazardous surface condition of the anticipated region of travel on the road.

According to some aspects, the multispectral light beam transmitted by the multispectral system is temporally successively and repeatedly, firstly directed towards a first set of points located to a potential encountering object in front of the vehicle for detecting said potential encountering object and secondly directed at a second set of points located on the road for determining the hazardous surface condition of the road, the direction of the multispectral light beam being controlled by at least one scanning mirror of the multispectral lidar system.

According to some aspects, the points in the first set of points are obtained by a first mean direction of the multispectral light beam that is inclined vertically between +/−2 degrees relative to a vehicle horizontal direction, and the points in the second set of points are obtained by a second mean direction of the multispectral light beam that is inclined vertically towards the road between 5 to 20 degrees relative to said vehicle horizontal direction.

According to some aspects, the points in the second set of points are scanned more frequently than the points of the first set of points for detecting a potential encountering object more frequently than sounding road to determine the hazardous surface condition in the anticipated region of travel of the vehicle.

According to some aspects, the points of the second set of points are scanned at least ten times more frequently than the points of the first set of points.

According to some aspects, the active safety routine is conducted by one of: (i) an adaptive cruise control (ACC) system; (ii) a collision avoidance system; (iii) an automatic emergency braking (AEB) system; (iv) a forward collision warning system; (v) a hill descent control system; (vi) an intelligent speed adaptation system; and (vii) an intelligent speed advice (ISA) system.

According to some aspects, the method further comprises:

the determining of a hazardous surface condition includes determining a degree of the hazardous surface condition.

According to some aspects, the method further comprises:

determining, based on the hazardous surface condition of the road, a friction value for the road; and

wherein the actuating of the active safety routine is based on the determination of the hazardous surface condition in that the friction value is used in a calculation for the active safety routine.

According to some aspects, the method further comprises:

determining, based on the hazardous surface condition of the road, a friction value for the road; and

wherein the actuating of the active safety routine is based on the determination of the hazardous surface condition in that the friction value is used in a calculation for when the active safety routine is actuated.

A second object of the invention is a system, embedded in a vehicle, for mitigating a hazardous surface condition of a road, the system comprising:

a multispectral lidar system, configured to transmit a multispectral light beam directed at an anticipated region of travel of the vehicle within the road;

an active safety system;

one or more non-transitory computer readable media storing instructions to:

(i) analyze a multispectral response, of a photodetector, to a return of the multispectral light beam;

(ii) determine, based on the analyzing of the response, a hazardous surface condition in the anticipated region of travel of the vehicle; and

(iii) actuate, using the active safety system and based on the determination of the hazardous surface condition, an active safety routine; and

wherein the analyzing of the response includes a time of flight analysis and a multispectral intensity analysis, the time of flight analysis determining a distance between the multispectral lidar system and at least one point inside the anticipated region of travel, and the multispectral intensity analysis determining signature information of material of said at least one point, said signature information comprising at least two intensities at different wavelength.

In some embodiments, one might also use one or more of the following features:

According to some aspects of the system:
the anticipated region of travel is a region of road excluding boundaries of the road by detecting boundaries features, boundaries features including lane markers, side rails, curbs, road signs, the boundaries features being detected by analyzing the multispectral response; and
the hazardous surface condition is determined based on the analyzing of the multispectral response corresponding to points on the road located only inside the anticipated region of travel

According to some aspects of the system, the multispectral light beam transmitted by the multispectral system scans both a potential encountering object to be detected in front of the vehicle and the road for determining the hazardous surface condition of the anticipated region of travel on the road.

According to some aspects of the system, the active safety routine is conducted by one of: (i) an adaptive cruise control (ACC) system; (ii) a collision avoidance system; (iii) an automatic emergency braking (AEB) system; (iv) a forward collision warning system; (v) a hill descent control system; (vi) an intelligent speed adaptation system; and (vii) an intelligent speed advice (ISA) system.

FIG. 2 includes a block diagram and flow chart 200 for a road aware ADAS. In this example the ADAS is an ACC system and the same sensing system is used directly by the ADAS 210 and by a surface condition detection system 220 to determine road surface conditions. As seen, the information obtained from sensing system 201 is provided not only to ADAS 210 but also to a surface condition detection system 220. In FIG. 2, the sensing system 201 can obtain both signature information for the surface condition detection system 220 and distance information for ADAS 210. For example, the sensing system could be a multispectral LIDAR system with beams that can be used to make both a time of flight analysis for determining distance (e.g., measuring the time of reflection from a potential obstruction or road boundary), and an intensity measurement for determining signature information (e.g., two intensities at different wavelengths providing signature information of a material). In specific embodiments, a single laser source can be used both for time of flight analyses and for obtaining signature information by splitting the beam into multiple wavelengths or sending out pulses with different wavelengths at different times.

Regardless of whether the same system is used to generate information for a surface condition detection system, such as surface condition detection system 220, and an active safety system, such as ADAS 210, the determined surface condition can be used by the active safety system to affect, in real time, the manner in which the active safety system actuates an active safety routine. In the example of FIG. 2, the information regarding the surface condition is used to calculate the braking time of the vehicle, which will then influence the calculation of the optimum following distance. The result of these differing actuations of the active safety routine are illustrated in FIG. 2 in which vehicle 221 in state 240 follows a vehicle 222 at a first distance when the surface condition is detected as being a flat dry road, and the same vehicle 221 follows vehicle 222, with all else equal, at a larger distance in state 250 after the surface condition detection system 220 on vehicle 221 has determined that the road is icy and braking will be more difficult. The output to user interface system 120 or vehicle control system 130 may have the same format in either case, but it will be optimized based on the detected road condition. In the example of an active safety system with a feedback loop involving control system 130, the detection of the surface condition can be conceptualized as a second feedback loop which constrains the stabilization point of the first feedback loop discussed above.

In specific embodiments of the invention, the surface condition detection system is focused upon an anticipated region of travel of the vehicle. The anticipated region of travel of the vehicle can be determined in various ways. The additional processing steps associated with this determination can be guided by the same sensing system used by the active safety system, the same sensing system used to generate information for determining the surface condition, or by an alternative dedicated system. For example, and with reference to FIG. 2, the determination of the anticipated region of travel could depend on information gathered by sensing system 201. The determination can include analyzing the road ahead to segment the road from the surroundings. The determination can include analyzing road boundaries such as side rails or lane dividers. The determination can also include analyzing the road in light of information regarding the motion of the vehicle itself, such as those produced by vehicle control system 130 in FIG. 2, to determine which portion of the road the vehicle will utilize. Focusing on the anticipated region of travel can help to further optimize the actuation of the active safety procedures and can, in specific cases, prevent false alarms provided by surface conditions located on the side of the road or in adjacent lanes that are unlikely to affect the nature of travel for a vehicle on the road.

In specific embodiments, a method is provided. The method is performed by a system embedded in a vehicle. The method includes transmitting, with a multispectral LIDAR system, a multispectral light beam directed at an anticipated region of travel of the vehicle within a road. The method also includes analyzing a response, of a photodetector, to a return of the multispectral light beam. The method also includes determining, based on the analyzing of the response, a hazardous surface condition in the anticipated region of travel of the vehicle. The method also includes actuating, based on the determination of the hazardous surface condition, an active safety routine.

In specific embodiments, a system is provided. The system is embedded in a vehicle and is for mitigating a hazardous surface condition of a road. The system includes a multispectral lidar system configured to transmit a multispectral light beam directed at an anticipated region of travel of the vehicle within the road. The system also includes an active safety system. The system also includes one or more non-transitory computer readable media storing instructions to: analyze a response, of a photodetector, to a return of the multispectral light beam; determine, based on the analyzing of the response, a hazardous surface condition in the anticipated region of travel of the vehicle; and (iii) actuate, using the active safety system and based on the determination of the hazardous surface condition, an active safety routine.

In specific embodiments another method is provided. The method is performed by a system embedded in a vehicle. The method includes transmitting an electromagnetic signal at an anticipated region of travel of the vehicle within a road. The method also includes analyzing, using a sensor, a return of the electromagnetic signal. The method also includes determining, based on the analyzing of the return, a hazardous surface condition in the anticipated region of travel of the vehicle. The method also includes modifying an actuation of an active safety routine based on the determination of the hazardous surface condition.

### BRIEF DESCRIPTION OF THE DRAWINGS

FIG. 1 illustrates a block diagram and flow chart showing the operation of an active safety system in accordance with the related art.

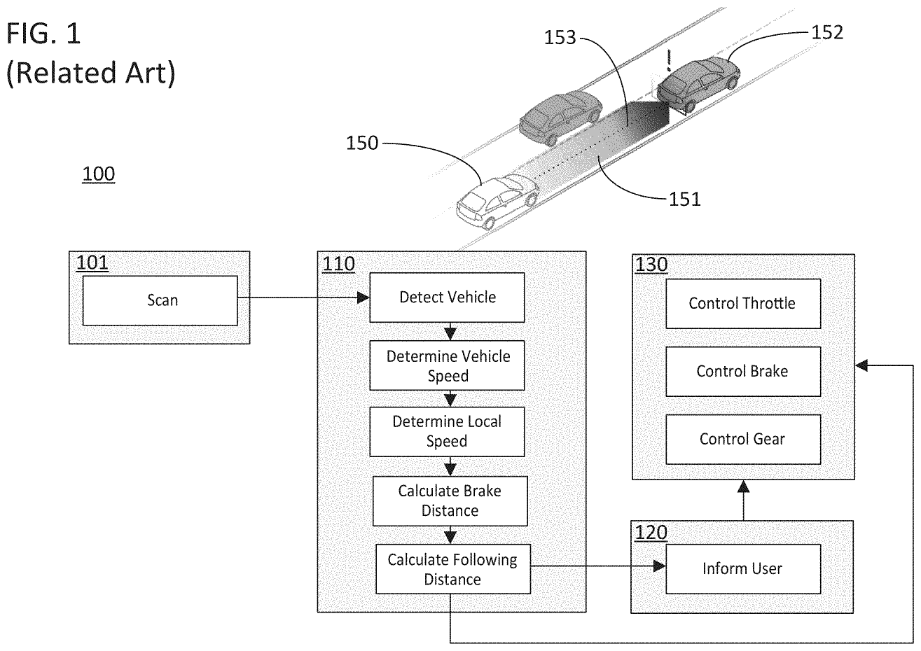

FIG. 2 illustrates a block diagram and flow chart showing the operation of an adaptive active safety system in accordance with specific embodiments of the invention disclosed herein.

FIG. 2A illustrates some features of the environment of use of the adaptive active safety system of FIG. 2.

FIG. 3 illustrates a flow chart for a set of methods for actuating an active safety routine that are in accordance with specific embodiments of the invention disclosed herein.

FIG. 4 illustrates a set of block diagrams for various sensing systems that can be utilized to generate information for a surface condition detection system in accordance with specific embodiments of the invention disclosed herein.

### DETAILED DESCRIPTION

Systems and methods involving adaptive active safety systems which utilize a sensing system to detect road conditions and actuate an active safety routine based on those detected road conditions in accordance with the summary above are disclosed below. In specific embodiments of the invention, the sensing system utilized by the active safety system to determine information about the environment generally is the same sensing system used to detect road conditions. However, the road conditions can also be determined by a separate dedicated system. In specific embodiments of the invention, the road condition is determined for an anticipated region of travel of a vehicle. The anticipated region of travel can further be determined by the same sensing system, or a separate dedicated system. The specific embodiments of these systems and methods disclosed in this section are provided for explanatory purposes and are not meant to limit the invention, the scope of which is provided by the appended claims.

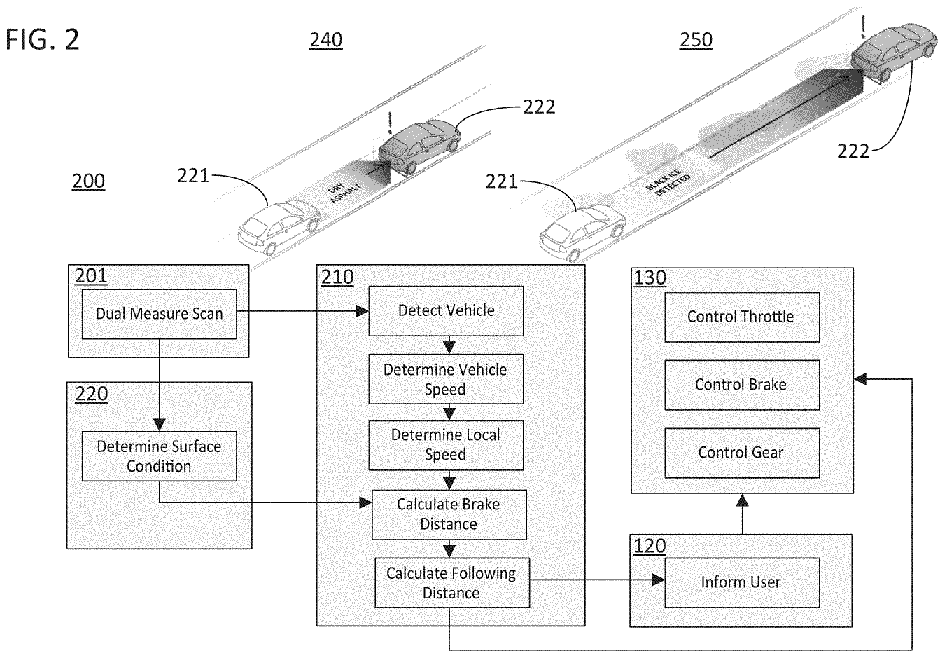

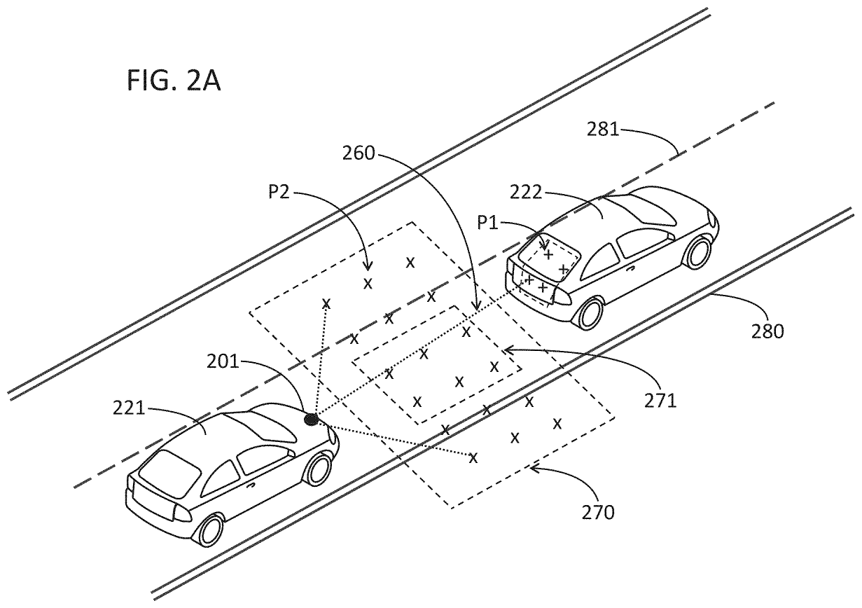

Referring again to FIG. 2, the flow chart is an example of implementation of an adaptive active safety system 200 according to specific embodiments of the invention. The example of vehicles in states 240 and 250 is an example of an Adaptive Cruise Control System (ACC) that adapts or tunes an optimum following distance on the bases of the road conditions. FIG. 2A is an enlarged view of state 240 of FIG. 2.

The adaptive active safety system 200 includes a sensing system 201 providing distance information 260 between the vehicle 221 and a potential encountering object in front of said vehicle 211, and a surface condition determination system 220 providing a road surface condition of an anticipated region of travel 271 of vehicle 211. The distance information 260 and the surface condition are both provided to the Advanced Driver Assistance System 210 (ADAS). In the embodiment of an ADAS being an ACC system and other security systems, the ADAS detects a potential encountering object that is a vehicle 222 in front of the vehicle 211.

The ADAS system detects a potential encountering object (e.g. detects vehicle 222), determines the potential encountering object speed (e.g. determines vehicle speed of vehicle 222), determines the local speed (i.e. the vehicle speed of the vehicle 221 on which the ADAS is located). Then, the ADAS determines a braking time and/or a brake distance based on at least the local speed of vehicle 221 and the surface condition provided by the surface condition detection system 220. Then, the ADAS 210 calculates a safe following distance based on the acquired information, such as the encountering object speed, local speed, braking time and/or brake distance, and provides said following distance to the user interface system 120 and/or the vehicle control system 130.

The vehicle control system 130 can control the throttle of engine, the braking force of each and/or all brakes, gear of vehicle 211.

The sensing system 201 is for example the same sensing system (for example a dual measure scanning system) that provides information to the ADAS system for detecting the potential encountering object (the vehicle 222) and to the surface condition determining system 220 for determining the road surface condition.

In specific embodiment, the sensing system 201 is a multispectral lidar system transmitting a multispectral light beam directed to various directions for scanning both the potential encountering object to be detected in front of the vehicle (350) and the road for determining the surface condition of the anticipated region of travel on the road.

In this process, as illustrated on FIG. 2A, the sensing system 201 of vehicle 221 is scanning a scanned region 270 of the road for example in front of the vehicle 221. The sensing system 201 can extract a portion of said scanned region 270 corresponding to the anticipated region of travel 271 of vehicle 221. The anticipated region of travel 271 is a region of the road where the vehicle 221 will travel in near future and for which evaluation of road surface condition is desired to anticipate the vehicle future displacement. The sensing system 201 is also scanning a potential encountering object (e.g. vehicle 222). The potential encountering object is for example ahead (in front of) the anticipated region of travel 271. The sensing system 201 is then can provide distance information 260 to the ADAS system 210.

The distance information 260 is a distance that should be greater than a maximum distance of scanning of the anticipated region of travel 271 as the surface condition should be determined between the vehicle 211 and the potential encountering object (vehicle 222).

In specific embodiment of the invention, the sensing system 201 is a multispectral lidar system transmitting a multispectral light beam. The multispectral light beam is temporally successively and repeatedly, firstly directed towards a first set of points P1 located to the potential encountering object (vehicle 222) in front of the vehicle 221 for detecting said potential encountering object and secondly directed at a second set of points P2 located on the road for determining the surface condition of the road, the direction of the multispectral light beam being controlled for example by at least one scanning mirror of the multispectral lidar system.

The points in the first set of points P1 may be obtained by a first mean direction of the multispectral light beam, and the points in the second set of points P2 are obtained by a second mean direction of the multispectral light beam that is inclined vertically towards the road. For example, the first mean direction is inclined vertically between +/−2 degrees relative to said vehicle horizontal direction. For example, the second mean direction is inclined between 5 to 20 degrees relative to a vehicle horizontal direction.

In specific embodiments of the invention, the points in the first set of points P1 are scanned more frequently than the points of the first set of points P2 for detecting the potential encountering object (vehicle 222) more frequently than sounding road to determine the road surface condition in the anticipated region of travel 271 of the vehicle 221. For example, the points of the first set of points P1 are scanned at least five or ten times more frequently than the points of the second set of points P1. Therefore, the potential encountering object can be detected more often than the road condition is analyzed. The number of points in the second set of points P2 could be more numerous than the number of points in the first set of points P1 to obtain a more accurate and more robust determination of surface condition. The determination of surface condition of said points on the road (second set of points P2) can take more time than the detection and/or determination of distance 260 of the potential encountering object (vehicle 222) as no intensity analysis and signature determination might be needed for that task. For both above reasons, the processing of more frequently scanning the first set of points P1 is more optimized. Additionally, such processing leads to a more safe control of vehicle 221, i.e. a more safe active safety system.

In specific embodiments of the invention, the anticipated region of travel 271 is a region of road excluding boundaries of the road by detecting boundaries features. The boundaries features may include lane markers 280, divider lines 281, side rails, curbs, road signs. The boundaries features can be detected by analyzing the multispectral response of the multispectral lidar system. The road surface condition can be then determined based on the analyzing of the multispectral response corresponding to points on the road located only inside the anticipated region of travel 271.

In specific embodiments of the invention, the actuating of an active safety routine is further based on the determination of the inclination of the anticipated region of travel 271 relative to an absolute horizontal direction, to identify if the anticipated region of travel is a rising portion of road or if the anticipated region of travel is a descendant portion of road, and influence the control provided by the active safety routine.

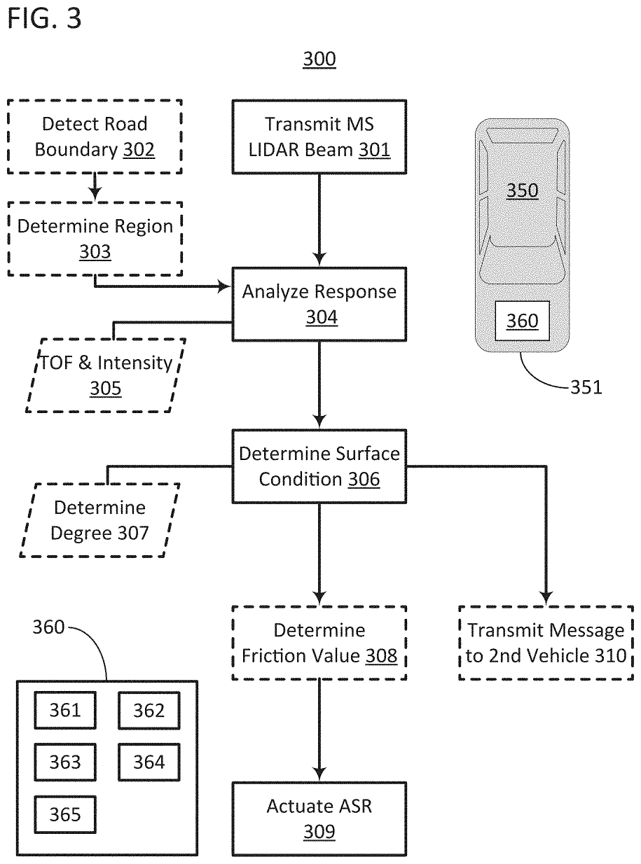

FIG. 3 includes a flow chart 300 for a set of methods for actuating an active safety routine that are in accordance with specific embodiments of the invention disclosed herein. The flow chart includes optional steps with dashed boundaries and sub-steps in tilted parallelograms attached to the steps for which they serve as component sub-steps. The flow chart serves as an outline for the remainder of this disclosure. The flow chart begins with steps executed by the sensing system, proceeds to steps associated with determining the road conditions, and concludes with steps taken to actuate an active safety routine based on the determined road conditions.

Flow chart 300 begins with steps executed by a sensing system to obtain information regarding a road condition. The sensing systems utilized by the vehicle can take many different forms. As mentioned above, sensing systems used in accordance with this disclosure can be active or passive. For example, the sensing system could be a passive hyper spectral camera or an active LIDAR sensing system. As active safety systems require some form of information regarding the environment of the vehicle, the same sensing system used to obtain that information can be used to obtain information regarding a road condition. For example, an active LIDAR can determine the distance to another vehicle and also provide information regarding the road condition. However, the systems can also be different. For example, an active LIDAR could determine the distance to another vehicle while a hyper spectral camera determined that the road was icy or wet. In the example of FIG. 3, the same sensing system 351 is an active multispectral LIDAR sensing system used for both the active safety system and for detecting the road condition.

In specific embodiments of the invention, the sensing systems disclosed herein can utilize sensor fusion to combine multiple sources of information. The fused information can be derived from active or passive sensors, data from the control system of the vehicle, or information pulled from a network connection on the vehicle. For example, readings from an active LIDAR sensing system which indicate a wet road surface, could be combined with information from a sensor used to detect rain for automatic windshield wipers and information from a network connection to a local weather surface to either reinforce a determination that a road surface is wet, or more accurately gauge how much water is on the road surface. The fused information could include optics for lane markers, text on signs, license plate numbers for tracking vehicles, weather information, and time of day information.

In specific embodiments of the invention, the sensing and computations systems utilized for the methods disclosed herein can be located in various places depending upon the application. For example, the sensing systems disclosed herein can be integrated with the vehicle on which the active safety routine will be actuated, can be located on a road infrastructure object for use in a V2I application, or can be located on an alternative vehicle for use in a V2V application. However, in the example utilized in flow chart 300, the sensing system 351 is a multispectral LIDAR system and is located on vehicle 350. Sensing system 351 is embedded along with a processing system 360 that can execute the determining, analyzing, and general computation steps associated with executing the methods illustrated by flow chart 300. Embedded system 360 can include a non-transitory computer readable medium 361 which stores instructions that can be executed by a processor to conduct the determining, analyzing, and generally computation steps disclosed herein. Embedded system 360 can also include a surface condition determination system 362, an active safety system 363, a user interface system 364, and a vehicle control system 365. The corresponding systems described above with reference to FIG. 2 are specific examples of these systems.

Active sensing systems used in accordance with this disclosure can include transmitting a sounding signal and analyzing the response of the sounding signal to the environment. In specific embodiments of the invention, the sounding signals disclosed herein can take on variant forms depending upon the desired analysis that will be conducted on the response of those sounding signals. The set of sounding signals for a given analysis can include a single signal, such as a laser pulse used for a time of flight ranging analysis, a set of multiple signals sent simultaneously using frequency or code multiplexing, or a set of multiple signals set at staggered times using time division multiplexing or phase shift multiplexing. The signals can be projected in patterns, such as structured light patterns, and the analysis can involve extracting depth information from a two-dimensional image of the return signals. In the example of FIG. 3, flow chart 300 begins with step 301 in which a multispectral LIDAR system transmits a multispectral light beam and continues with a step 304 in which the response of a photodetector to the return of the multispectral light beam is analyzed.

In specific embodiments of the invention, the sounding signals can be transmitted in various fashions depending upon the application. The sounding signals may be broadcast isotropically from the vehicle or directed. The signals can be directed by a fixed placement of the sensing system relative to the vehicle or actively directed via moving parts or the variation of the electronic properties of solid-state elements. The sounding signals disclosed herein can be directed at an anticipated region of travel of a vehicle within a road. For example, the multispectral light beam transmitted in step 301 can be transmitted specifically at an anticipated region of travel of vehicle 350. However, the sounding signals may also be transmitted without ex ante knowledge of the anticipated region of travel.

In the context of multispectral LIDAR, a multispectral light beam used as a sounding signal, such as in step 301, can be a single light beam with a temporally variant wavelength or multiple simultaneously projected light beams each with a variant wavelength. The light beams can be transmitted from vehicle 350 from one or more projection points that are either static with respect to vehicle 350 or movable. The vehicle may be designed to transmit the light beams in any direction from the vehicle based on the anticipated region of travel including movement in a reverse direction. The light beams may be actively directed at an anticipated region of travel if the anticipated region of travel is solved for or otherwise investigated prior to the execution of step 301. The peak power of the multispectral LIDAR system may be designed to generate actionable sounding signals at a distance of tens of meters. In specific approaches, the multispectral LIDAR system will emit a peak power above 20 Watts.

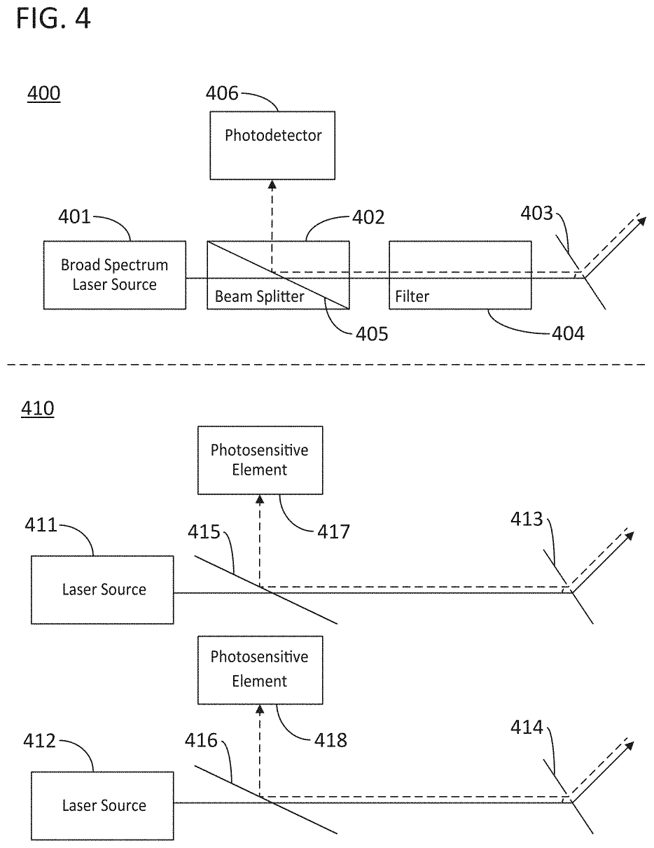

The sensing system can include a laser source and a photodetector. The laser source can be a single broad-spectrum laser source used in combination with a beam splitter. The laser source can alternatively be a set of multiple laser sources. The detector of the sensing system can include a filter array or tunable filer. In specific embodiments of the invention, the multiple laser sources will be tuned to emit sounding signals with multiple wavelengths emitted at different times either at a specific point or in a patter. In specific embodiments of the invention, the single laser source will emit light through a filter that is tunable to change the wavelength of the emitted light temporally to generate different wavelength signals in frequency. More specific examples of these sensing systems are provided with reference to FIG. 4 as follows.

FIG. 4 presents block diagrams of two sensing systems that can be used in accordance with specific embodiments of the invention. For example, the sensing systems could be used in place of sensing system 351 in FIG. 3. The illustrated sensing systems are configured to utilize multispectral light beams with different characteristics and using different approaches. The sensing systems are configured to both emit light and receive a response from that emission. The solid arrows in each diagram represent the light beam as it is emitted, and the dotted line represents the response.

FIG. 4 provides a multispectral LIDAR system 400 with a single laser source in the form of a broad-spectrum laser source 401. The multispectral light beam generated by multispectral LIDAR system 400 includes multiple wavelengths emitted at different times. System 400 includes a separating unit 402, a wavelength selection unit 404, and a scanning mirror 403. The scanning mirror can be a micro-electrical-mechanical (MEMS) system or any scanning mechanism capable of orienting itself relative to the light beam. For example, the scanning mirror 403 could be a 1-dimensional MEMS mirror with a diameter of around 4 mm.

Multispectral LIDAR system 400 can include a single photodetector 406, a beam splitter 405 located in separating unit 402, and a filter in wavelength selection unit 404. Photodetector 406 can be a broadband detector configured to detect light responsive to all the different wavelengths that can be emitted by multispectral LIDAR system 400. Element 404 can include a filter used to select the wavelength of light that will be emitted from the broad-spectrum laser source and the wavelength of light that will be admitted and routed to separating unit 402. The filter can be a filter array or tunable filter. Separating unit 402 can include a beam splitter 405 to deflect the received light and provide it to photodetector 406. While not illustrated, beam splitter 405 could alternatively be configured to deflect light of different wavelengths to multiple photosensitive elements where each photosensitive element in the set of photosensitive elements is uniquely operatively sensitive to a spectrum of light in the multispectral light beam. The set of photosensitive elements and the set of potential wavelengths of light that can be emitted from LIDAR system 400 could have the same cardinality. Also, while not illustrated, multiple branches of elements 402, 403, and 404 could be attached to broad-spectrum laser source 401 with each branch optimized for transmitting light of a different wavelength. As such, the multispectral light beam used by such a system could include multiple wavelengths emitted at the same time from a single laser source such as broad-spectrum laser source 401.

FIG. 4 also provides a multispectral LIDAR system 410 with a set of laser sources including laser source 411 and laser source 412. The system 410 can be configured to generate a multispectral light beam with a set of beams that are emitted simultaneously. The number of laser sources does not need to be set at two and is done so here strictly for illustrative purposes. The multispectral light beam generated by multispectral LIDAR system 410 includes multiple wavelengths emitted at the same time. System 410 includes multiple scanning mirrors 413 and 414 and multiple beam splitters 415 and 416. The scanning mirrors can be configured to transmit the multiple light beams to a single target. The scanning mirrors can have the same characteristics as scanning mirror 403. Multispectral LIDAR system 410 can include a photodetector with multiple photosensitive elements 417 and 418. The photosensitive element in the set of photosensitive elements can be uniquely operatively sensitive to a spectrum of light in the multispectral light beam. In the illustrated case, the photosensitive elements would be configured to be uniquely operatively sensitive to the spectrum of light defined by the light beam routed thereto by their associated beam splitter. As illustrated, the set of photosensitive elements and the set of beams in the multispectral light beam can have the same cardinality.

Regardless of whether the sensing system utilized is active or passive, sensed signals will be analyzed to determine the road condition ahead. For example, flow chart 300 continues with a step 304 of analyzing a response of a photodetector, to a return of the multispectral light beam transmitted in step 301. The photodetector could have the characteristics of photodetector 406 or the photodetector utilizing photosensitive elements 417 and 418. The analysis can be conducted by sensing system 351 itself, surface condition determination system 362, or by active safety system 363. The analysis can include detecting road boundaries for guiding further soundings or limiting further analysis on the response of the sounding signals. The analysis can include an analysis required by the active safety system such as a ranging analysis (e.g., a time of flight analysis) on a sounding signal. The analysis can include an analysis required by a road condition detection system such as a signature analysis. The signature analysis can include an intensity analysis to determine the absorption of a surface that reflected the sounding signal. The analysis can include a signature analysis such as a scaterometry analysis to determine the scattering properties of the surface that reflected the sounding signal. The analysis can include a signature analysis such as an interferometric analysis to determine the phase shifting properties of the surface that reflected the sounding signals. In specific embodiments of the invention, the sounding signals of the sensing system will be utilized in more than one analysis and by more than one system.

Flow chart 300 includes a component step 305 in which the analyzing of the response step 304 includes both a time of flight analysis and an intensity analysis. The time of flight analysis can be a standard ranging analysis in which the round-trip time of the sounding signal is measured to extrapolate the distance from the target of the sounding signal to the vehicle. The time of flight analysis can be used by an active safety system, such as active safety system 363, to determine the distance to an obstruction, road boundary, or alternative vehicle. The intensity analysis can include measuring the absorption of a given target to more than one wavelength of light. The different wavelengths can be transmitted simultaneously, and the responses can be measured by dedicated photosensitive elements or they can be transmitted in sequence and be measured by dedicate elements or a detector and filter combination. The difference in the intensities can provide a description of the characteristics of the sounding target.

In specific embodiments of the invention, the vehicle will determine its anticipated region of travel in order to focus the action of the sensing or analysis of road conditions. Determining the motion of travel can require the use of a dedicated sensing system or it can also utilize the sensing system used to determine road conditions (e.g., sensing system 351). The anticipated region of travel of the device can then be used to guide the sensing of the road condition such as by guiding the transmission of active sensing signals onto the road. Alternatively or in combination, the determination of the anticipated region of travel can be used to guide the analysis of the response the sensing system to limit the analysis to responses received from that anticipated region of travel. The direction of travel can be determined with reference to a detected set of road boundaries. Alternatively or in combination, determining the anticipated region of travel can be conducted entirely without reference to road boundaries such as by relying entirely on the known motion of the vehicle, the state of the vehicle's control system, and possibly predictive analytics regarding the future state of the vehicle.

As mentioned, in specific embodiments of the invention, the vehicle will determine a set of at least one road boundaries on the road and utilize the obtained information to determine the anticipated region of travel of the vehicle. The set of at least one road boundaries can include a single landmark such as a road sign, or a collection of road boundaries such as painted dashed lines. The road boundaries may already be detected for purposes of the active safety system such that no additional software or hardware is required for step 302 to be conducted for the case of a road aware adaptive safety system. Furthermore, the set of road boundaries can be discovered using the same sensing signals used to determine the surface condition. The road boundaries in these approaches could be three-dimensional lane markers such as Botts' dots, curbs, or road signs. Alternatively, the set of road boundaries can be determined using a separate system such as an optical visible light, infrared, or ultraviolet sensing system. The sensing system could also be directed at a different angle than the main sensing system such as by being guided off to the sides of the vehicle for this purpose. The flow chart of FIG. 3 is an example of approaches in which road boundaries are detected in a step 302, and the anticipated region of travel is determined in a step 303 based on the detection of those road boundaries. As illustrated, the anticipated region of travel is then used in a step 304 to guide the analysis of the received sounding signals. As mentioned above, step 303, and potentially step 302, can be executed in combination with information from control system 365. For example, the control system 365 could include information that the vehicle is merging left or right in a controlled manner and ignore one set of road boundaries in the direction of the merge to assure that the road on the alternative side of the road boundaries and towards which the vehicle is transferring is properly analyzed.

After the response of the sounding signals have been analyzed, the system can determine, based on the analyzing of the response information, a surface condition of the road. The determination can be a determination regarding a hazardous surface condition. The determination can be made in the anticipated region of travel of the vehicle. In the example of FIG. 3, the step 306 involves determining, based on the analyzing of the response in step 304, a hazardous surface condition in the direction of travel. The hazardous surface condition is determined in the direction of travel because knowledge of the direction of travel was used to focus the analysis in step 304.

In specific embodiments of the invention, the determination of the surface condition can be made based upon a signature of the road surface derived from analyzing the sounding signals. The vehicle can store a database of signatures for this purpose (e.g., snow, water on asphalt, gravel, etc.) to be used to determine the surface condition. For example, a multispectral signature produced in step 304 could be applied to a database of multispectral signatures associated with such conditions. The database can be accessed by applying the signature to a feature detector followed by a classifier to identify the signature applying to a specific class. The signature can also include additional data fused with the output of the analysis of the sensing system's data, and this fused data can likewise be applied to a feature detector and classifier, or otherwise used to search a database.

The determination step could involve the determination of a gradation of the road condition, the binary presence of absence of a surface condition, or the determination of multiple conditions. In the example of a database of different conditions, the signature could be associated with entries “ice” or “no ice” in the database, alternatively the signature could indicate a degree of intensity of a condition such as on a scale of zero to one where zero represented a perfectly even surface and one represented a condition nearly certain to cause massive tire damage. Regardless of whether the response and analysis generated a signature, the execution of the determination step could involve determining such gradations. Step 306 is shown as having an optional component step 307 in which a gradation of a given condition is generated. The execution of optional component step 307 could capture the degree of intensity of a given hazardous condition. The degree of intensity can affect how the active safety system is actuated in response to the condition. For example, an automatic stabilization system could slow the car down when detecting ice of over 30% while the stabilization system would shut the car down is detecting ice over 60%. The determination can also involve an analysis of the surface topology of the road surface as generated during the analysis. For example, the sounding signals could have generated a signature indicative of the presence of potholes or other uneven surface in the road which would be determined by the surface condition determination system upon analyzing the signature. The determination can also be a determination of a mixed condition; for example, the determination could determine that a road surface is a wet road and that the road has only been wet for about 15 minutes. This determination could involve the vehicle keeping track of how long the car has been detecting a wet road for or could involve an application of sensor fusion in which a networked weather report centered on an anticipated region of travel indicated that it had been raining for 15 minutes. The recency of the wet condition could be indicative of a higher level of hazard as the water on the road may be mixed with oil that has not fully been rinsed from the road by the water. Notably, the same condition could be determined from a different analysis where the signature of the road surface was precise enough to distinguish a road that is wet from water with a road that is wet from a mixture of oil and water.

Upon determining a road condition, the vehicle can actuate an active safety routine based on the road condition. For example, the vehicle can actuate an active safety routine based on the determination of a hazardous surface condition. FIG. 3 includes a step 309 of actuating, based on the determination of the hazardous surface condition in step 306, an active safety routine. Step 309 can involve triggering the active safety routine upon detecting the hazardous surface condition or modifying the actuation of the active safety routine upon detecting the hazardous surface condition. FIG. 3 also includes the optional step 308 of determining based on the hazardous surface condition of the road determined in step 306, a friction value for the road. The friction value for the road, or an equivalent objective metric regarding the surface condition of the road, could then be used as an input variable for the execution of an active safety routine to either alter when the routine was actuated or the manner in which the active safety routine was actuated. In this example, the actuating of the active safety routine in step 309 is based on the determination of the hazardous surface condition in step 306 in that the friction value determined in optional step 308 is used in a calculation of the active safety routine. In embodiments in which the degree of a hazardous condition is detected, the calculations of an active safety system can be affected by this degree. The degree can also be used as an input variable to the execution of the active safety routine in the same way that the friction variable is used in the example of FIG. 3.

Different active safety systems can utilize information regarding the surface condition in various ways. After determining a surface condition, the system can actuate an active safety routine based on that surface condition. For example, the active safety routine could be a automatic emergency braking (AEB) ADAS which actuates at a point determined by the surface condition. The detection of the surface condition could include detecting the fact that the road is iced over and calculating an expected grip value for the road. The collision avoidance system could use this information to determine that an automatic braking action should be executed at 15 meters from an obstruction as opposed to 5 meters from that same obstruction with all else held equal. As another example, the active safety routine could be an ACC ADAS which alters the manner in which it is actuated based on the surface condition. The detection of the surface condition could include the same fact that the road is iced over and the same expected grip value could be determined. However, the ACC ADAS instead utilize that information to determine the safe following distance that should be applied during the actuation of the ADAS and follow a car at 20 meters instead of 5 meters. In other embodiments, the actuating of the active safety routine is based on the determination of the hazardous surface condition in that the actuating is conducted in response to the determining of a presence of the hazardous surface condition. For example, a collision avoidance ADAS could detect a surface hazard condition so acute that it would need to immediately execute to avoid the hazard entirely. Alternatively, the same collision avoidance ADAS could take evasive action slightly sooner than it would have otherwise in response to detecting the road had less grip that the nominal routine was designed for.

Approaches in alignment with the methods illustrated by FIG. 3 can be applied to numerous ADAS applications. The application to ACC, AEB, and collision avoidance ADASs have been described above. However, the approaches are also particularly applicable to forward collision warning, hill descent control, intelligent speed adaptation or intelligent speed advice (ISA), lane departure warning systems, lane change assistance, pedestrian protection systems, automatic lane centering (ALC), intersection assistance, and any other ADAS whose successful or efficient actuation is effected by road conditions. Forward collision warnings can be triggered earlier on roads with less grip. Hill descent control systems can increase the internal relationship of the system between gear size and slope. Intelligent speed adaptation or ISA systems can warn or protect users from speeding in jurisdictions were the speed limit is set by road conditions. Lane departure warning systems or lane change assistance can assure a vehicle makes gradual corrections or more cautions lane changes when roads are wet. Pedestrian protection and intersection assistance ADAS can increase the guard bands of uncertainty for slippery or uneven roads.

Vehicles can also transmit messages indicative of the road condition for usage by other vehicles or road infrastructure. The messages can be sent to infrastructure or directly to alternative vehicles. In the example of FIG. 3, an optional step 310 involves transmitting a message, regarding the hazardous surface condition determined in step 306 to a second vehicle on the road. The message can be broadcast from the device for consumption by multiple vehicles or targeted specifically for an alternative vehicle. The message can be received by one or more alternative vehicles and allow them to actuate their own active safety routines in response to that determination. The messages can be sent along with identification information concerning the location of the hazardous condition. The receiving vehicles can then choose to operate on messages in which the identified hazardous condition is in an anticipated region of travel for that vehicle.

In specific embodiments of the invention, the method of the invention includes the following provisions.

Provision 1: A method, performed by a system embedded in a vehicle, comprising the steps of:
transmitting, with a multispectral lidar system, a multispectral light beam directed at an anticipated region of travel of the vehicle within a road;
analyzing a response, of a photodetector, to a return of the multispectral light beam;
determining, based on the analyzing of the response, a hazardous surface condition in the anticipated region of travel of the vehicle; and
actuating, based on the determination of the hazardous surface condition, an active safety routine.

Provision 2: The method of provision 1, wherein the multispectral lidar system emits a peak power above 20 W.

Provision 3: The method of provision 1, the analyzing of the response includes a time of flight analysis and an intensity analysis.

Provision 4: The method of provision 1, the active safety routine is conducted by one of: (i) an adaptive cruise control (ACC) system; (ii) a collision avoidance system; (iii) an automatic emergency breaking (AEB) system; (iv) a forward collision warning system; (v) a hill descent control system; (vi) an intelligent speed adaptation system; and (vii) an intelligent speed advice (ISA) system.

Provision 5: The method of provision 1, wherein:
the multispectral lidar system includes a single laser source; and
the multispectral light beam includes multiple wavelengths emitted at different times.

Provision 6: The method of provision 1, wherein:
the multispectral lidar system includes a single laser source; and
the multispectral light beam includes multiple wavelengths emitted at the same time.

Provision 7: The method of provision 1, wherein:
the multispectral lidar system includes: (i) a single laser source; (ii) a beam splitter; and (iii) a filter;
the photodetector includes a set of photosensitive elements;
the multispectral light beam includes a set of beams; and
the set of photosensitive elements and the set of beams have the same cardinality.

Provision 8: The method of provision 1, wherein:
the photodetector includes a set of photosensitive elements; and
each photosensitive element in the set of photosensitive elements is uniquely operatively sensitive to a spectrum of in the multispectral light beam.

Provision 9: The method of provision 1, wherein:
the photodetector includes a photosensitive element; and
the photosensitive element is operatively sensitive to all spectrums in the multispectral light beam.

Provision 10: The method of provision 1, wherein:
the determining includes determining a degree of the hazardous surface condition.

Provision 11: The method of provision 1, further comprising:
determining, based on the hazardous surface condition of the road, a friction value for the road; and
wherein the actuating of the active safety routine is based on the determination of the hazardous surface condition in that the friction value is used in a calculation for the active safety routine.

Provision 12: The method of provision 1, wherein:
determining, based on the hazardous surface condition of the road, a friction value for the road; and
wherein the actuating of the active safety routine is based on the determination of the hazardous surface condition in that the friction value is used in a calculation for when the active safety routine is actuated.

Provision 13: The method of provision 1, wherein:
the actuating of the active safety routine is based on the determination of the hazardous surface condition in that the actuating is conducted in response to the determining of a presence of the hazardous surface condition.

Provision 14: The method of provision 1, wherein:
the actuating of the active safety routine is based on the determination of the hazardous surface condition in that a manner in which the active safety routine is actuated is modified according to a degree of the hazardous surface condition.

In specific embodiments of the invention, the system of the invention includes the following provisions.

Provision 15: A system, embedded in a vehicle, for mitigating a hazardous surface condition of a road, the system comprising:
a multispectral lidar system, configured to transmit a multispectral light beam directed at an anticipated region of travel of the vehicle within the road;
an active safety system; and
one or more non-transitory computer readable media storing instructions to:
(i) analyze a response, of a photodetector, to a return of the multispectral light beam;
(ii) determine, based on the analyzing of the response, a hazardous surface condition in the anticipated region of travel of the vehicle; and
(iii) actuate, using the active safety system and based on the determination of the hazardous surface condition, an active safety routine.

Provision 16: The system of provision 15, wherein the multispectral lidar system emits a peak power above 20 W.

Provision 17: The system of provision 15, the analyzing of the response includes a time of flight analysis and an intensity analysis.

Provision 18: The system of provision 15, the active safety routine is conducted by one of: (i) an adaptive cruise control (ACC) system; (ii) a collision avoidance system; (iii) an automatic emergency breaking (AEB) system; (iv) a forward collision warning system; (v) a hill descent control system; (vi) an intelligent speed adaptation system; and (vii) an intelligent speed advice (ISA) system.

Provision 19: The system of provision 15, wherein:
the multispectral lidar system includes a single laser source; and
the multispectral light beam includes multiple wavelengths emitted at different times.

Provision 20: The system of provision 15, wherein:
the multispectral lidar system includes a single laser source; and
the multispectral light beam includes multiple wavelengths emitted at the same time.

Provision 21: The system of provision 15, wherein:
the multispectral lidar system includes: (i) a single laser source; (ii) a beam splitter; and (iii) a filter;
the photodetector includes a set of photosensitive elements;
the multispectral light beam includes a set of beams; and
the set of photosensitive elements and the set of beams have the same cardinality.

Provision 22: The system of provision 15, wherein:
the photodetector includes a set of photosensitive elements; and
each photosensitive element in the set of photosensitive elements is uniquely operatively sensitive to a spectrum of in the multispectral light beam.

Provision 23: The system of provision 15, wherein:
the photodetector includes a photosensitive element; and
the photosensitive element is operatively sensitive to all spectrums in the multispectral light beam.

Provision 24: The system of provision 15, wherein:
the photodetector includes a photosensitive element; and
the photosensitive element is operatively sensitive to all spectrums in the multispectral light beam.

Provision 25: The system of provision 15, wherein:
the determining includes determining a degree of the hazardous surface condition.

Provision 26: The system of provision 15, wherein the one or more non-transitory computer readable media further store instructions to:
determine, based on the hazardous surface condition of the road, a friction value for the road; and
wherein the actuating of the active safety routine is based on the determination of the hazardous surface condition in that the friction value is used in a calculation for the active safety routine.

Provision 27: The system of provision 20, wherein the computer readable media further store instructions to:
determine, based on the hazardous surface condition of the road, a friction value for the road; and
wherein the actuating of the active safety routine is based on the determination of the hazardous surface condition in that the friction value is used in a calculation for when the active safety routine is actuated.

Provision 28: The system of provision 15, wherein:
the actuating of the active safety routine is based on the determination of the hazardous surface condition in that the actuating is conducted in response to the determining of a presence of the hazardous surface condition.

Provision 29: The system of provision 15, wherein:
the actuating of the active safety routine is based on the determination of the hazardous surface condition in that the manner in which the active safety routine is actuating is modified according to a degree of the hazardous surface condition.

Provision 30: A method, performed by a system embedded in a vehicle, comprising the steps of:
transmitting an electromagnetic signal at an anticipated region of travel of the vehicle within a road;
analyzing, using a sensor, a return of the electromagnetic signal;
determining, based on the analyzing of the return, a hazardous surface condition in the anticipated region of travel of the vehicle; and
modifying an actuation of an active safety routine based on the determination of the hazardous surface condition.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

1. A method, performed by a system embedded in a vehicle, comprising:
transmitting, with a multispectral lidar system, a multispectral light beam directed at an anticipated region of travel of the vehicle within a road;
analyzing a multispectral response, of a photodetector, to a return of the multispectral light beam;
determining, based on the analyzing of the multispectral response, a hazardous surface condition in the anticipated region of travel of the vehicle; and
actuating, based on the determining of the hazardous surface condition, an active safety routine; and
wherein the analyzing of the multispectral response includes a time of flight analysis and a multispectral intensity analysis, the time of flight analysis determining a distance between the multispectral lidar system and at least one point inside the anticipated region of travel, and the multispectral intensity analysis determining signature information of material of said at least one point, said signature information comprising at least two intensities at different wavelength.

2. The method of claim 1, wherein:
the anticipated region of travel is a region of road excluding boundaries of the road by detecting boundaries features, boundaries features including lane markers, side rails, curbs, road signs, the boundaries features being detected by analyzing the multispectral response; and
the hazardous surface condition is determined based on the analyzing of the multispectral response corresponding to points on the road located only inside the anticipated region of travel.

3. The method of claim 1, wherein the actuating is further based on determining an inclination of the anticipated region of travel relative to an absolute horizontal direction, to identify if the anticipated region of travel is a rising portion of road or if the anticipated region of travel is a descendant portion of road.

4. The method of claim 1, wherein the multispectral light beam transmitted by the multispectral lidar system scans both a potential encountering object to be detected in front of the vehicle and the road for determining the hazardous surface condition of the anticipated region of travel on the road.

5. The method of claim 1, wherein the multispectral light beam transmitted by the multispectral lidar system is temporally successively and repeatedly, firstly directed towards a first set of points located to a potential encountering object in front of the vehicle for detecting said potential encountering object and secondly directed at a second set of points located on the road for determining the hazardous surface condition of the road, the direction of the multispectral light beam being controlled by at least one scanning mirror of the multispectral lidar system.

6. The method of claim 5, wherein the points in the first set of points are obtained by a first mean direction of the multispectral light beam that is inclined vertically between +/−2 degrees relative to a vehicle horizontal direction, and the points in the second set of points are obtained by a second mean direction of the multispectral light beam that is inclined vertically towards the road between 5 to 20 degrees relative to said vehicle horizontal direction.

7. The method of claim 5, wherein the points in the second set of points are scanned more frequently than the points of the first set of points for detecting a potential encountering object more frequently than sounding road to determine the hazardous surface condition in the anticipated region of travel of the vehicle.

8. The method of claim 7, wherein the points of the second set of points are scanned at least ten times more frequently than the points of the first set of points.

9. The method of claim 1, wherein the active safety routine is conducted by one of: (i) an adaptive cruise control (ACC) system; (ii) a collision avoidance system; (iii) an automatic emergency braking (AEB) system; (iv) a forward collision warning system;
(v) a hill descent control system; (vi) an intelligent speed adaptation system; and (vii) an intelligent speed advice (ISA) system.

10. The method of claim 1, wherein:
the determining of a hazardous surface condition includes determining a degree of the hazardous surface condition.

11. The method of claim 1, further comprising:
determining, based on the hazardous surface condition of the road, a friction value for the road; and
wherein the actuating of the active safety routine is based on the determining of the hazardous surface condition in that the friction value is used in a calculation for the active safety routine.

12. The method of claim 1, wherein:
determining, based on the hazardous surface condition of the road, a friction value for the road; and
wherein the actuating of the active safety routine is based on the determining of the hazardous surface condition in that the friction value is used in a calculation for when the active safety routine is actuated.

13. A system, embedded in a vehicle, for mitigating a hazardous surface condition of a road, the system comprising:
a multispectral lidar system, configured to transmit a multispectral light beam directed at an anticipated region of travel of the vehicle within the road;
an active safety system;
one or more non-transitory computer readable media storing instructions to:
(i) analyze a multispectral response, of a photodetector, to a return of the multispectral light beam;
(ii) determine, based on the analyzing of the multispectral response, a hazardous surface condition in the anticipated region of travel of the vehicle; and
(iii) actuate, using the active safety system and based on the determining of the hazardous surface condition, an active safety routine; and
wherein the analyzing of the multispectral response includes a time of flight analysis and a multispectral intensity analysis, the time of flight analysis determining a distance between the multispectral lidar system and at least one point inside the anticipated region of travel, and the multispectral intensity analysis determining signature information of material of said at least one point, said signature information comprising at least two intensities at different wavelength.

14. The system of claim 13, wherein:
the anticipated region of travel is a region of road excluding boundaries of the road by detecting boundaries features, boundaries features including lane markers, side rails, curbs, road signs, the boundaries features being detected by analyzing the multispectral response; and
the hazardous surface condition is determined based on the analyzing of the multispectral response corresponding to points on the road located only inside the anticipated region of travel

15. The system of claim 13, wherein the multispectral light beam transmitted by the multispectral lidar system scans both a potential encountering object to be detected in front of the vehicle and the road for determining the hazardous surface condition of the anticipated region of travel on the road.

16. The system of claim 13, wherein the active safety routine is conducted by one of: (i) an adaptive cruise control (ACC) system; (ii) a collision avoidance system; (iii) an automatic emergency braking (AEB) system; (iv) a forward collision warning system; (v) a hill descent control system; (vi) an intelligent speed adaptation system; and (vii) an intelligent speed advice (ISA) system.
